(19) United States
(12) Patent Application Publication
(10) Pub. No.: US 2009/0073091 A1
(43) Pub. Date: Mar. 19, 2009

(54) PLASMA DISPLAY APPARATUS AND METHOD OF DRIVING THE SAME

(75) Inventors: Kirack PARK, Gumi-city (KR); Jongwoon BAE, Gumi-city (KR); Seonghwan RYU, Gumi-city (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/116,240

(22) Filed: May 7, 2008

(30) Foreign Application Priority Data
Sep. 17, 2007 (KR) 10-2007-0094205

(51) Int. Cl. G09G 3/28

(52) U.S. Cl. 345/60

(57) ABSTRACT

A plasma display apparatus and a method of driving the same are disclosed. The plasma display apparatus includes a plasma display panel including scan and sustain electrodes, a scan driver, and a sustain driver. The scan driver supplies a first reset signal, of which a lowest voltage is a first voltage, to the scan electrode during reset periods of a plurality of subfields and supplies a scan signal, of which a lowest voltage is a third voltage lower than the first voltage, to the scan electrode during address periods. The sustain driver supplies a first sustain bias voltage to the sustain electrode during the reset periods and supplies a second sustain bias voltage higher than the first sustain bias voltage to the sustain electrode during the address periods.

This application claims the benefit of Korean Patent Application No. 10-2007-0094205 filed on Sep. 17, 2007, which is hereby incorporated by reference.

### BACKGROUND

1. Field

An exemplary embodiment relates to a plasma display apparatus and a method of driving the same.

2. Description of the Background Art

A plasma display apparatus includes a plasma display panel and a driver for driving the plasma display panel.

The plasma display panel has the structure in which barrier ribs formed between a front panel and a rear panel forms unit discharge cell or a plurality of discharge cells. Each discharge cell is filled with an inert gas containing a main discharge gas such as neon (Ne), helium (He) or a mixture of Ne and He, and a small amount of xenon (Xe). The plurality of discharge cells form one pixel. For example, a red discharge cell, a green discharge cell, and a blue discharge cell form one pixel. When the plasma display panel is discharged by applying a high frequency voltage to the discharge cell, the inert gas generates vacuum ultraviolet rays, which thereby cause phosphors formed between the barrier ribs to emit light, thus displaying an image. Since the plasma display apparatus can be manufactured to be thin and light, it has attracted attention as a next generation display device.

### SUMMARY

An exemplary embodiment provides a plasma display apparatus and a method of driving the same capable of preventing the generation of an erroneous discharge and generating a stable address discharge by changing a lowest voltage of a reset signal and a sustain bias voltage in each subfield.

In one aspect, a plasma display apparatus comprises a plasma display panel including a scan electrode and a sustain electrode, a scan driver that supplies a first reset signal, of which a lowest voltage is a first voltage, to the scan electrode during reset periods of a plurality of subfields and supplies a scan signal, of which a lowest voltage is a third voltage lower than the first voltage, to the scan electrode during address periods following the reset periods, and a sustain driver that supplies a first sustain bias voltage to the sustain electrode for a supply time shorter than a supply time of the first reset signal in the reset periods and supplies a second sustain bias voltage higher than the first sustain bias voltage to the sustain electrode during the address periods.

In another aspect, a plasma display apparatus comprises a plasma display panel including a scan electrode and a sustain electrode, a sustain driver that supplies a first sustain bias voltage to the sustain electrode during set-down periods of reset periods of a plurality of subfields and supplies a second sustain bias voltage higher than the first sustain bias voltage to the sustain electrode during address periods following the reset periods, and a scan driver that supplies a reset falling signal to the scan electrode during the supply of the first sustain bias voltage and supplies a scan signal to the scan electrode during the supply of the second sustain bias voltage, wherein the second sustain bias voltage changes in each of the plurality of subfields, and a lowest voltage of the reset falling signal changes in each of the plurality of subfields.

In still another aspect, a method of driving a plasma display apparatus including a scan electrode and a sustain electrode, the method comprises supplying a first reset signal, of which a lowest voltage is a first voltage, to the scan electrode during reset periods of a plurality of subfields, and supplying a scan signal, of which a lowest voltage is a third voltage lower than the first voltage, to the scan electrode during address periods following the reset periods, and supplying a first sustain bias voltage to the sustain electrode for a supply time shorter than a supply time of the first reset signal in the reset periods, and supplying a second sustain bias voltage higher than the first sustain bias voltage to the sustain electrode during the address periods.

The plasma display apparatus and the method of driving the same according to the exemplary embodiment can prevent the generation of an erroneous discharge and generate a stable address discharge by changing a lowest voltage of a reset signal and a sustain bias voltage in each subfield.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 shows a plasma display apparatus according to an exemplary embodiment;

FIG. 2 shows a structure of a plasma display panel of the plasma display apparatus according to the exemplary embodiment;

FIG. 3 shows a frame for achieving a gray scale of an image in the plasma display apparatus according to the exemplary embodiment;

FIG. 4 is a diagram for explaining an operation of the plasma display apparatus according to the exemplary embodiment;

FIG. 5 is a table showing a relationship between a first sustain bias voltage and a second sustain bias voltage;

FIG. 6 is a diagram for explaining a reason to change a magnitude of a second sustain bias voltage depending on subfields;

FIG. 7 is a diagram for explaining changes in a highest voltage of a last sustain signal in each subfield; and

FIG. 8 is a diagram for explaining first and second reset signals.

### DETAILED DESCRIPTION

Reference will now be made in detail embodiments of the invention examples of which are illustrated in the accompanying drawings.

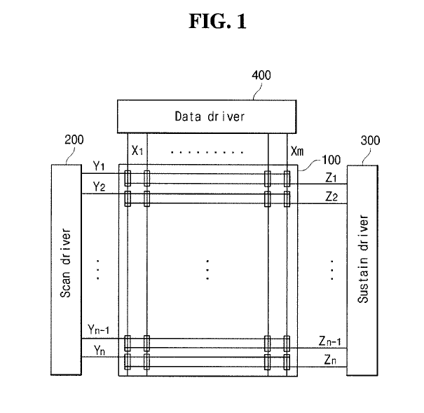

FIG. 1 shows a plasma display apparatus according to an exemplary t.

As shown in FIG. 1, the plasma display apparatus according to the exemplary embodiment includes a plasma display panel 100, a scan driver 200, a sustain driver 300, and a data driver 400.

The plasma display panel 100 includes a front panel (not shown) and a rear panel (not shown) which coalesce with each other at a given distance. The plasma display panel 100 includes scan electrodes Y1 to Yn, sustain electrodes Z1 to Zn, and address electrodes X1 to Xm.

The scan driver 200 supplies first falling signals to the scan electrodes Y1 to Yn during a pre-reset period prior to a reset period to thereby stably form wall charges on the electrodes. The scan driver 200 supplies reset signals to the scan electrodes Y1 to Yn during the reset period to thereby uniformly form wall charges inside discharge cells. The reset signal may include a first reset signal of which a lowest voltage is a first voltage, and a second reset signal of which a lowest voltage is a second voltage different from the first voltage.

The scan driver 200 supplies scan signals to the scan electrodes Y1 to Yn during an address period to thereby select discharge cells to be turned on. The scan driver 200 supplies sustain signals to the scan electrodes Y1 to Yn during a sustain period to thereby generate a sustain discharge inside the selected discharge cells. A lowest voltage of the scan signal may include a third voltage lower than the first and second voltages.

The scan driver 200 supplies erase signals to the scan electrodes Y1 to Yn after the supply of the last sustain signal.

The sustain driver 300 supplies first rising signals to the sustain electrodes Z1 to Zn during the pre-reset period, supplies a first sustain bias voltage to the sustain electrodes Z1 to Zn during a set-down period, and supplies a second sustain bias voltage different from the first sustain bias voltage to the sustain electrodes Z1 to Zn during the address period. A sustain bias signal includes the first and second sustain bias voltages.

The sustain driver 300 supplies the sustain signals to sustain electrodes Z1 to Zn during the sustain period.

The sustain driver 300 supplies the first sustain bias voltage to the sustain electrodes Z1 to Zn during the supply of the erase signals to the scan electrodes Y1 to Yn.

The data driver 400 receives data mapped for each subfield by a subfield napping circuit (not shown) after being inverse-gamma corrected and error-diffused through an inverse gamma correction circuit (not shown) and an error diffusion circuit (not shown), or the like.

The data driver 400 supplies data signals corresponding to the scan signals to the address electrodes X1 to Xm in response to a data timing control signal received from a timing controller (not shown).

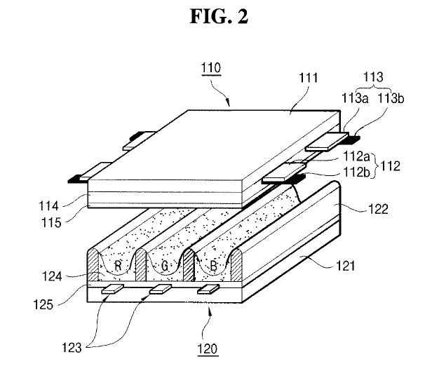

FIG. 2 shows a structure of a plasma display panel of the plasma display apparatus according to the exemplary embodiment.

As shown in FIG. 2, the plasma display panel 100 includes a front panel 110 and a rear panel 120 which coalesce with each other at a given distance therebetween. The front panel 110 includes a front substrate 111 on which a scan electrode 112 and a sustain electrode 113 are positioned parallel to each other. The rear panel 120 includes a rear substrate 121 on which an address electrode 123 is positioned to intersect the scan electrode 112 and the sustain electrode 113.

The scan electrode 112 and the sustain electrode 113 generate a mutual discharge therebetween in a discharge cell and maintain a discharge of the discharge cell.

A light transmittance and an electrical conductivity of the scan electrode 112 and the sustain electrode 113 need to be considered so as to emit light produced inside the discharge cells to the outside and to secure the driving efficiency. Accordingly, the scan electrode 112 and the sustain electrode 113 each include transparent electrodes 112a and 113a made of a transparent material, e.g., indium-tin-oxide (ITO) and bus electrodes 112b and 113b made of a metal material such as silver (Ag).

An upper dielectric layer 114 covering the scan electrode 112 and the sustain electrode 113 is positioned on the front substrate 111 on which the scan electrode 112 and the sustain electrode 113 are positioned. The upper dielectric layer 114 limits discharge currents of the scan electrode 112 and the sustain electrode 113 and provides electrical insulation between the scan electrode 112 and the sustain electrode 113.

A protective layer 115 is positioned on an upper surface of the upper dielectric layer 114 to facilitate discharge conditions. The protective layer 115 may be formed of a material with a high secondary electron emission coefficient, for example, magnesium oxide (MgO).

The address electrode 123 positioned on the rear substrate 121 applies a data signal to the discharge cell.

A lower dielectric layer 125 covering the address electrode 123 is positioned on the rear substrate 121 on which the address electrode 123 is positioned.

Barrier ribs 122 are positioned on the lower dielectric layer 125 to partition the discharge cells. A phosphor 124 emitting visible light for an image display during an address discharge is positioned inside the discharge cells partitioned by the barrier ribs 122. The phosphor 124 may include red (R), green (G) and blue (B) phosphors.

Driving signals are applied to the scan electrode 112, the sustain electrode 113, and the address electrode 123 to generate a discharge inside the discharge cells of the plasma display panel. Hence, an image is displayed on the plasma display panel.

Since FIG. 2 has shown and described only an example of the plasma display panel applicable to the exemplary embodiment, the exemplary embodiment is not limited thereto.

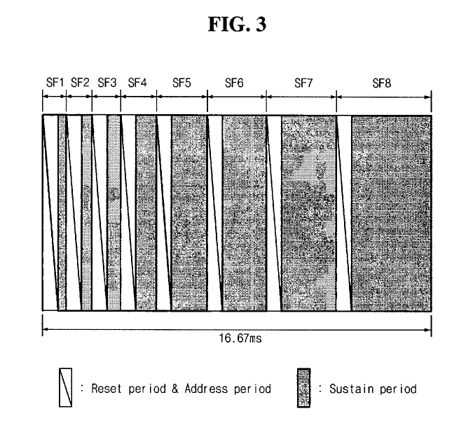

FIG. 3 shows a frame for achieving a gray scale of an image in the plasma display apparatus according to the exemplary embodiment.

As shown in FIG. 3, a frame for achieving a gray scale of an image in the plasma display apparatus according to the exemplary embodiment is divided into a plurality of subfields each having a different number of emission times.

Each subfields may be subdivided into a reset period for initializing all the discharge cells, an address period for selecting cells to be discharged, and a sustain period for representing a gray scale in accordance with the number of discharges.

For instance, if an image with 256-level gray scale is to be displayed, a frame period (i.e., 16.67 ma) corresponding to 1/60 second, as shown in FIG. 3, is divided into 8 subfields SF1 to SF8. Each of the 8 subfields SF1 to SF8 is subdivided into a reset period, an address period, and a sustain period.

The number of sustain signals supplied during a sustain period of a subfield determines a weight value of the subfield. In other words, a predetermined weight value may be assigned to each subfield using a sustain period of each subfield. For instance, in such a method of setting a weight value of a first subfield at 20 and a weight value of a second subfield at 21, a weight value of each subfield can be set so that weight values of subfields increase in a ratio of 2′ (where, n=0, 1, 2, 3, 4, 5, 6, 7). An image with various gray levels can be displayed by controlling the number of sustain signals supplied during a sustain period of each subfield depending on a weight value of each subfield.

The plasma display apparatus according to the exemplary embodiment uses a plurality of frames to display an image for 1 second. For instance, 60 frames are used to display an image for 1 second.

While one frame includes 8 subfields in FIG. 3, the number of subfields constituting one frame may variously be changed. For instance, one frame may include 10 or 12 subfields.

The image quality in the plasma display apparatus depends on the number of subfields constituting a frame. For instance, when 12 subfields constitute a frame, the number of representable weight values of an image may be 2¹². When 10 subfields constitute a frame, the number of representable weight values of an image may be 2¹⁰.

Further, while the subfields are arranged in increasing order of weight values in FIG. 3, the subfields may be arranged in decreasing order of weight values. The subfields may be arranged regardless of weight values so as to prevent a contour noise generated when an image is displayed.

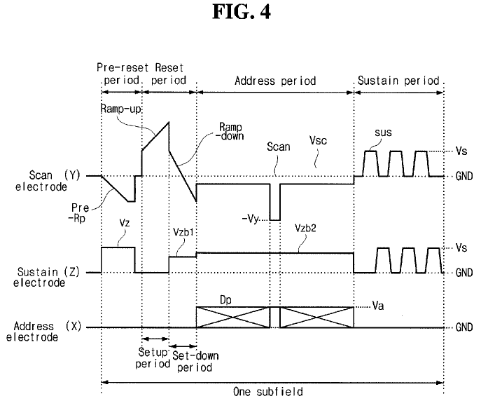

FIG. 4 is a diagram for explaining an operation of the plasma display apparatus according to the exemplary embodiment in any one of a plurality of subfields of a frame. The scan driver 200, the sustain driver 300, and the data driver 400 of FIG. 1 may supply driving signals to the scan electrode Y, the sustain electrode Z, and the address electrode X during at least one of a pre-reset period, a reset period, an address period, and a sustain period.

As shown in FIG. 4, a frame may include a pre-reset period prior to a reset period. The scan driver 200 may supply a first falling signal Pre-Rp, which gradually falls from a ground level voltage GND to a lowest voltage of a reset signal, to the scan electrode Y during the pre-reset period. Hence, one voltage source may supply a lowest voltage of the first falling signal Pre-Rp and the lowest voltage of the reset signal.

Although FIG. 4 has shown the case where the first falling signal Pre-Rp falls to the lowest voltage of the reset signal, the exemplary embodiment is not limited thereto. The first falling signal Pre-Rp may fall to a voltage level lower or higher than the lowest voltage of the reset signal. This may depend on a temperature of the plasma display panel or the surroundings of the panel.

The sustain driver 300 may supply a first rising signal Vz to the sustain electrode Z during the supply of the first falling signal Pre-Rp. A polarity of the first rising signal Vz is opposite to a polarity of the first falling signal Pre-Rp.

A highest voltage of the first rising signal Vz may be substantially equal to at least one of a first sustain bias voltage Vzb1, a second sustain bias voltage Vzb2, or a sustain voltage Vs corresponding to a highest voltage of a sustain signal SUS. This may depend on the temperature of the plasma display panel, the surroundings of the panel, or a lowest voltage of a first reset signal.

As above, wall charges with a predetermined polarity may be accumulated on the scan electrode Y, and wall charges with a polarity opposite the polarity of the wall charges accumulated on the scan electrode Y may be accumulated on the sustain electrode Z by supplying the first falling signal Pre-Rp and the first rising signal Vz to the scan electrode Y and the sustain electrode Z during the pre-reset period, respectively.

The signal supply during the pre-reset period can reduce a magnitude of a highest voltage of the reset signal, and thus can reduce the quantity of light generated during the reset period. Hence, a contrast characteristic can be improved.

The scan driver 200 supplies the reset signal to the scan electrode Y during the reset period. The reset signal includes a reset rising signal Ramp-Up rising up to the highest voltage of the reset signal and a reset falling signal Ramp-Down falling up to the lowest voltage of the reset signal. The reset signal may include a first reset signal of which a lowest voltage is a first voltage, and a second reset signal of which a lowest voltage is a second voltage different from the first voltage.

The scan driver 200 may supply the reset rising signal Ramp-Up to the scan electrode Y during a setup period of the reset period. The reset rising signal Ramp-Up generates a weak dark discharge inside the discharge cells of the whole screen. Hence, wall charges of a positive polarity are accumulated on the sustain electrode Z and the address electrode X, and wall charges of a negative polarity are accumulated on the scan electrode Y.

The scan driver 200 may supply the reset falling signal Ramp-down, which falls from a positive voltage level lower than a highest voltage of the reset rising signal Ramp-Up to a given voltage level lower than the ground level voltage GND, to the scan electrode Y during a set-down period of the reset period, thereby generating a weak erase discharge inside the discharge cells. Hence, wall charges excessively accumulated inside the discharge cells are erased, and the remaining wall charges are uniformly distributed inside the discharge cells to the extent that an address discharge can stably occur.

A slope of the first falling signal Pre-Rp may be substantially equal to a slope of the reset falling signal Ramp-down. Hence, the remaining wall charges can be more uniformly distributed inside the discharge cells.

Accordingly, a setup discharge with a sufficient intensity can occur during the reset period, and thus can stably perform the initialization of wall charges during the reset period. Even if the highest voltage of the reset rising signal Ramp-Up further falls, a setup discharge with a sufficient intensity can occur.

A first subfield in tire order among a plurality of subfields of a frame may include a pre-reset period, or 2 or 3 subfields of the frame may include a pre-reset period so as to secure drive time.

The sustain driver 300 supplies a sustain bias signal to the sustain electrode Z during the set-down period and the address period. The sustain bias signal includes the first sustain bias voltage vzb1 and the second sustain bias voltage vzb2. The sustain driver 300 supplies the first sustain bias voltage Vzb1 to the sustain electrode Z during the set-down period and supplies the second sustain bias voltage Vzb2 to the sustain electrode Z during the address period so as to prevent the generation of an erroneous discharge between the sustain electrode Z and the scan electrode Y.

In other words, the application of the second sustain bias voltage Vzb2 higher than the first sustain bias voltage Vzb1 during the address period can prevent the generation of an opposite discharge between the sustain electrode Z and the address electrode X, and also can more efficiently generate an address discharge between the scan electrode Y and the address electrode X.

A difference between the first and second sustain bias voltages Vzb1 and Vzb2 may lie in a range between 2V and 10V.

The scan driver 200 may supply a scan signal Scan of a negative polarity falling from a scan bias voltage Vsc to the scan electrode Y during the address period. The scan bias voltage Vsc may be lower than the ground level voltage GND. The data driver 400 may supply a data signal Dp of a positive polarity corresponding to the scan signal Scan to the address electrode X.

When a voltage difference between the scan signal Scan and the data signal Ep is added to a wall voltage by wall charges produced during the reset period, an address discharge may occur more stably inside the discharge cells, to which the data signal Dp is supplied, by supplying the first and second sustain bias voltages Vzb1 and Vsb2 each having a different magnitude.

A lowest voltage of the scan signal Scan may be lower than the lowest voltage of the reset signal. In other words, a third voltage corresponding to the lowest voltage of the scan signal Scan may be lower than the first voltage corresponding to the lowest voltage of the first reset signal and the second voltage corresponding to the lowest voltage of the second reset signal. Hence, a magnitude of a data voltage Va corresponding to the highest voltage of the data signal Dp may be reduced.

Accordingly, even if a magnitude of the data voltage Va is reduced, the address discharge can smoothly occur between the scan electrode Y and the address electrode X by the application of the third voltage.

A difference between the first voltage of the first reset signal and the third voltage of the scan signal may be larger than a difference between the first sustain bias voltage and the second sustain bias voltage. Hence, a proper amount of wall charges can remain inside the discharge cells to the extent that the address discharge stably occurs.

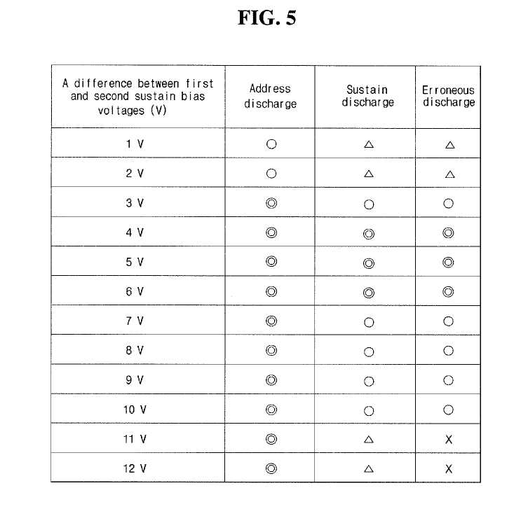

Further, the magnitude of the data voltage Va of the data signal Ep can be reduced due to the above voltage difference, and also the address discharge can stably occur. Hence, it is easy to generate a stable sustain discharge due to the generation of stable address discharge. In other words, a difference between the first sustain bias voltage and the second sustain bias voltage may be smaller than a difference between the first voltage of the first reset signal and the third voltage of the scan signal. The difference between the first sustain bias voltage and the second sustain bias voltage will be described later with reference to FIG. 5.

Wall charges are formed inside the discharge cells selected by performing the address discharge to the extent that a discharge occurs every time the sustain voltage Vs is applied.

During the sustain period, the scan driver 200 and the sustain driver 300 supply sustain signals SUS to the scan electrode Y and the sustain electrode Z, respectively. As a wall voltage inside the discharge cells selected by performing the address discharge is added to the sustain signal SUS, every time the sustain signal SUS is applied, a sustain discharge occurs between the scan electrode Y and the sustain electrode Z.

Although it is not shown in FIG. 4, the scan driver 200 may supply an erase signal to the scan electrode Y or the sustain electrode Z after the supply of the last sustain signal during the sustain period so as to erase wall charges remaining in the discharge cells after the generation of the last sustain discharge.

Although FIGS. 1 to 4 have shown the case where the scan driver 200 and the sustain driver 300 operate independent of each other, the scan driver 200 and the sustain driver 300 may be integrated into one driver.

FIG. 5 is a table showing a state of an address discharge, a sustain discharge, and an erroneous discharge generated when a difference between the first sustain bias voltage Vzb1 and the second sustain bias voltage Vzb2 changes from 1V to 12V. In FIG. 5, the lowest voltage (i.e., the third voltage) of the scan signal is lower than the lowest voltage (i.e., the first voltage) of a first reset falling signal.

In FIG. 5, ⊚ indicates that an erroneous discharge does not occur and wall charges are uniformly distributed inside discharge cells to the extent that an address discharge stably occurs and a sustain discharge easily occurs; ∘ indicates a relatively good state; Δ indicates a relatively bad state (in other words, Δ means a discharge state is not good); and X indicates that an erroneous discharge occurs and an excessive or insufficient amount of wall charges are distributed inside discharge cells to the extent that an address discharge unstably occurs and a sustain discharge unstably occurs.

When the difference between the first sustain bias voltage Vzb1 and the second sustain bias voltage Vzb2 is equal to or lower than 2V, an address discharge stably occurs, but wall charges may be excessively formed inside the discharge cells after the address discharge. Hence, a sustain discharge may unstably occur and an erroneous discharge may occur.

When the difference between the first and second sustain bias voltages Vzb1 and Vzb2 is higher than 10V, an address discharge very stably occurs, but an insufficient amount of wall charges may be formed inside the discharge cells after the address discharge. Hence, a sustain discharge may unstably occur and an erroneous discharge may occur.

When the difference between the first and second sustain bias voltages Vzb1 and Vzb2 is 2V to 10V, an address discharge very stably occurs, and a proper amount of wall charges may be formed inside the discharge cells after the address discharge. Hence, a sustain discharge may stably occur and a probability of the generation of an erroneous discharge may be reduced. When the difference between the first and second sustain bias voltages Vzb1 and Vzb2 is 4V to 6V, an address discharge and a sustain discharge more stably occur and an erroneous discharge does not occur.

As above, because the scan driver supplies the scan signal having the third voltage lower than the first voltage of the first reset falling signal to the scan electrode during the address period while the sustain driver supplies the second sustain bias voltage Vzb2 to the sustain electrode under condition that the difference between the first and second sustain bias voltages Vzb1 and Vzb2 is 2V to 1V, an erroneous discharge can be prevented. Hence, an address discharge can stably occur. Further, because a proper amount of wall charges are uniformly formed inside the discharge cells after the address discharge, a sustain discharge can stably occur.

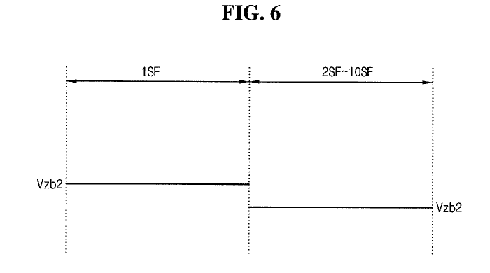

FIG. 6 is a diagram for explaining a reason to change a magnitude of a second sustain bias voltage depending on subfields.

As show in FIG. 6, a magnitude of the second sustain bias voltage Vzb2 in a first subfield 1SF may be different from a magnitude of the second sustain bias voltage Vsb2 in the other subfields 2SF to 10SF. In other words, a magnitude of the second sustain bias voltage Vzb2 in the first subfield 1SF may be larger than a magnitude of the second sustain bias voltage Vzb2 in the other subfields 2SF to 10SF.

Because the first subfield 1SF has a lower weight value than weight values of the other subfields 2SF to 10SF, the number of turned-on discharge cells in the first subfield 1SF is less than the number of turned-on discharge cells in the other subfields 2SF to 10SF. Hence, a priming effect cannot be expected, and the amount of wall charges accumulated by an address discharge during an address period of the first subfield 1SF may be insufficient. In this case, although a sustain signal is supplied during a sustain period of the first subfield 1SF, a sustain discharge may not occur because of an insufficient amount of wall charges.

Accordingly, a magnitude of the second sustain bias voltage Vzb2 in the first subfield 1SF may be larger than a magnitude of the second sustain bias voltage Vzb2 in the other subfields 2SF to 10SF so as to form a sufficient amount of wall charges during the address period of the first subfield 1SF.

Because the other subfields 2SF to 10SF have a higher weight value than the weight value of the first subfield 1SF, the magnitude of the second sustain bias voltage Vzb2 in the other subfields 2SF to 10SF does not need to be larger than the magnitude of the second sustain bias voltage Vzb2 in the first subfield 1SF.

For instance, in case that the second sustain bias voltages Vzb2 having an equal magnitude are supplied in all the subfields 1SF to 10SF, an excessive amount of wall charges are formed during address periods of the other subfields 2SF to 10SF, and thus an erroneous discharge may occur in turned-off discharge cells during sustain periods.

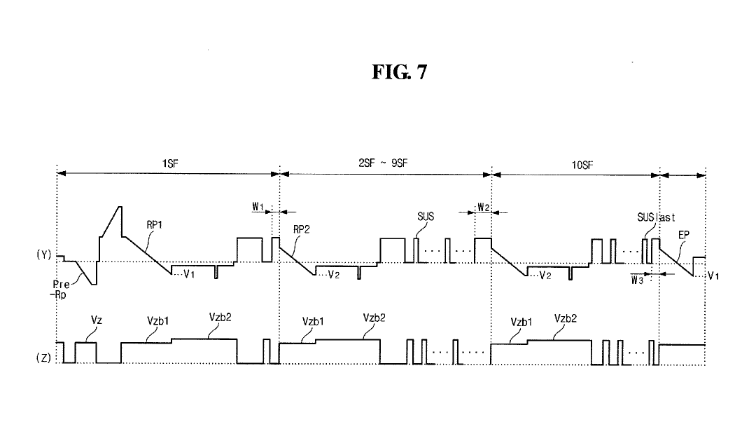

FIG. 7 is a diagram for explaining changes in a highest voltage of a last sustain signal in each subfield.

As shown in FIG. 7, the scan driver 200 supplies a first reset signal RP1, of which a lowest voltage is a first voltage V1, to the scan electrode Y during a reset period of a first subfield 1SF, and supplies a second reset signal RP2, of which a lowest voltage is a second voltage V2, to the scan electrode Y during a reset period of a second subfield.

While the first voltage V1 or the second voltage V2 is supplied, the sustain driver 300 supplies a sustain bias signal, which rises from the first sustain bias voltage Vzb1 to the second sustain bias voltage Vzb2, to the sustain electrode Z. In other words, the sustain bias signal changes from the first sustain bias voltage Vzb1 to the second sustain bias voltage Vzb2 during the supply of the first voltage V1 or the second voltage V2.

The first subfield 1SF may be a first subfield in time order among the plurality of subfields 1SF to 10SF. The second subfield may mean the remaining subfields except the first subfield 1SF.

Therefore, the first reset signal RP1 is supplied to the scan electrode Y during the reset period of the first subfield 1SF, and the second reset signal RP2 is supplied to the scan electrode Y during the reset periods of the other subfields 2SF to 10SF.

The first voltage V1 of the first reset signal RP1 in the first subfield 1SF may be lower than the second voltage V2 of the second reset signal RP2 in the other subfields 2SF to 10SF. Hence, because a weak erase discharge may occur in the discharge cells for a relatively long period of time in the first subfield 1SF, an excessive amount of wall charges non-uniformly distributed inside the discharge cells may be sufficiently erased. As a result, the remaining wall charges can be uniform after the weak erase discharge.

The first voltage V1 may lie substantially in a range between −92V to −88V, and the second voltage V2 may lie substantially in a range between −87V to −83V.

A highest voltage of a last sustain signal supplied to the scan electrode Y during a sustain period may change in each subfield. In other words, a supply time of a highest voltage of a last sustain signal may change in each subfield.

More specifically, a supply time W1 of a highest voltage of a last sustain signal supplied during a sustain period of the first subfield 1SF may be shorter than a supply time W2 of a highest voltage of a last sustain signal supplied during sustain periods of the other subfields 2SF to 1SF.

Further, a supply time WE of a highest voltage of a last sustain signal supplied during a sustain period of a last subfield (i.e., the tenth subfield 10SF in FIG. 7) may be shorter than the supply time W2 of the highest voltage of the last sustain signal supplied during the sustain periods of the other subfields 2SF to 9SF.

The center of light can be prevented from moving to the first subfield 1SF by setting the supply time W2 of the last sustain signal in the other subfields 2SF to 9SF to be longer than the supply tire W1 of the last sustain signal in the first subfield 1SF. In other words, the center of light can be prevented from leaning toward one side of a frame, and also a sufficient amount of wall charges can be formed inside the discharge cells.

This is because a last sustain discharge produced by a last sustain signal in a subfield is used to initialize the discharge cells during a reset period of a next subfield. In other words, because a distribution state of the wall charges may be different from each other during the reset periods of the plurality of subfields, a distribution state of the wall charges during the reset periods can be improved by adjusting a width of a last sustain signal in each subfield.

An erase signal EP may be supplied to the scan electrode Y after the supply of a last sustain signal SUS-last during a sustain period of the last subfield 10SF of a frame and before the supply of the first reset signal RP1 during a reset period of a first subfield of a next frame. Hence, the remaining wall charges before the reset period of the next frame can be uniformly distributed inside the discharge cells. This is because an erase discharge produced by the erase signal EP erases the wall charges non-uniformly distributed.

The erase signal EP is a signal with a gradually falling voltage over time. A highest voltage of the erase signal EP, a lowest voltage V1 of the erase signal EP, and a falling slope of the erase signal EP may be substantially equal to a highest voltage of the second reset signal RP2, the lowest voltage V1 of the first reset signal RP1, falling slopes of the first and second reset signals RP1 and RP2, respectively.

The erase signal EP may be supplied to the scan electrode Y during an erase period following the sustain period or during a pre-reset period prior to the reset period.

Since the erase signal EP is supplied to the scan electrode to thereby uniform the wall charges inside the discharge cells, the erase signal EP may be supplied during at least one of a pre-reset period, a reset period, a sustain period, or an erase period.

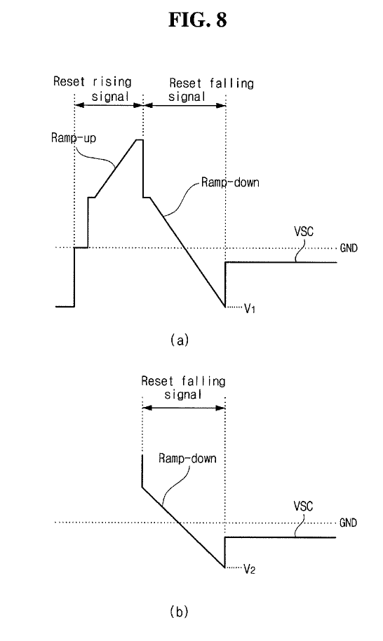

FIG. 8 is a diagram for explaining first and second reset signals.

As shown in FIG. 8, the scan driver 200 supplies a first reset signal, of which a lowest voltage is a first voltage, to the scan electrode Y during a reset period of a first subfield of a plurality of subfields, and supplies a second reset signal, of which a lowest voltage is a second voltage V2 different from the first voltage, to the scan electrode Y during reset periods of the other subfields except the first subfield from the plurality of subfields.

In FIG. 8, (a) shows the first reset signal, and (b) shows the second reset signal.

A voltage range from the lowest voltage to a highest voltage of the first reset signal may be wider than a voltage range from the lowest voltage to a highest voltage of the second reset signal. For instance, the highest voltage of the first reset signal may be higher than the highest voltage of the second reset signal, and the lowest voltage of the first reset signal may be lower than the lowest voltage of the second reset signal.

Because the first reset signal having the voltage range wider than the voltage range of the second reset signal is supplied in the first subfield, the wall charges can be sufficiently accumulated inside the discharge cells of the entire screen and the wall charges accumulated inside the discharge cells can be sufficiently erased. Hence, the remaining wall charges can be uniform.

Therefore, although the second reset signal having the smaller voltage range is supplied in the other subfields, a proper amount of wall charges may remain inside the discharge cells to the extent that an address discharge can stably occur.

The highest voltage of the first reset signal may substantially range from 230V to 240V, and the highest voltage of the second reset signal may substantially range from 183V to 193V. Since the lowest voltages of the first and second reset signals were described with reference to FIG. 7, a description thereof is omitted.

The wall charges can remain more uniformly inside the discharge cell due to the first and second reset signals having the above-described range, and also a proper amount of wall charges can continuously remain to the extent the address discharge can stably occur.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel including a scan electrode and a sustain electrode;
a scan driver that supplies a first reset signal, of which a lowest voltage is a first voltage, to the scan electrode during reset periods of a plurality of subfields and supplies a scan signal, of which a lowest voltage is a third voltage lower than the first voltage, to the scan electrode during address periods following the reset periods; and
a sustain driver that supplies a first sustain bias voltage to the sustain electrode during the reset periods and supplies a second sustain bias voltage higher than the first sustain bias voltage to the sustain electrode during the address periods.

2. The plasma display apparatus of claim 1, wherein the plurality of subfields include a first subfield and a second subfield, and
the scan driver supplies the first reset signal to the scan electrode during a reset period of the first subfield and supplies a second reset signal, of which a lowest voltage is a second voltage different from the first voltage, to the scan electrode during a reset period of the second subfield.

3. The plasma display apparatus of claim 2, wherein the first subfield is a first subfield in time order among the plurality of subfields.

4. The plasma display apparatus of claim 2, wherein the third voltage is lower than the first voltage and the second voltage.

5. The plasma display apparatus of claim 4, wherein the first voltage is lower than the second voltage.

6. The plasma display apparatus of claim 2, wherein a highest voltage of the first reset signal is higher than a highest voltage of the second reset signal.

7. The plasma display apparatus of claim 6, wherein a highest voltage of a last sustain signal supplied to the scan electrode during a sustain period following the address period changes in each of the plurality of subfield.

8. The plasma display apparatus of claim 1, wherein a difference between the first sustain bias voltage and the second sustain bias voltage is smaller than a difference between the first voltage and the third voltage.

9. The plasma display apparatus of claim 1, wherein the scan driver supplies a first falling signal to the scan electrode before the supply of the first reset signal, and the sustain driver supplies a first rising signal to the sustain electrode during the supply of the first falling signal.

10. The plasma display apparatus of claim 9, wherein a highest voltage of the first rising signal is substantially equal to at least one of the first sustain bias voltage, the second sustain bias voltage, or a highest voltage of a sustain signal.

11. The plasma display apparatus of claim 1, wherein a difference between the first sustain bias voltage and the second sustain bias voltage lies in a range between 2V and 10V.

12. The plasma display apparatus of claim 1, wherein the plurality of subfields constitute a frame, and
after a last sustain signal is supplied during a sustain period of a last subfield of the frame in time order, an erase signal is supplied.

13. A plasma display apparatus comprising:
a plasma display panel including a scan electrode and a sustain electrode;
a sustain driver that supplies a first sustain bias voltage to the sustain electrode during set-down periods of reset periods of a plurality of subfields and supplies a second sustain bias voltage higher than the first sustain bias voltage to the sustain electrode during address periods following the reset periods; and
a scan driver that supplies a reset falling signal to the scan electrode during the supply of the first sustain bias voltage and supplies a scan signal to the scan electrode during the supply of the second sustain bias voltage,
wherein the second sustain bias voltage changes in each of the plurality of subfields, and a lowest voltage of the reset falling signal changes in each of the plurality of subfields.

14. The plasma display apparatus of claim 13, wherein the lowest voltage of the reset falling signal is higher than a lowest voltage of the scan signal and is lower than a lowest voltage of a sustain signal supplied to the scan and sustain electrodes after the address period.

15. The plasma display apparatus of claim 13, wherein the scan driver supplies a first falling signal to the scan electrode prior to the supply of the reset falling signal, and the sustain driver supplies a second rising signal to the sustain electrode during the supply of the first falling signal.

16. The plasma display apparatus of claim 15, wherein the first falling signal gradually falls to the lowest voltage of the reset falling signal.

17. The plasma display apparatus of claim 15, wherein a highest voltage of the second rising signal is substantially equal to at least one of the first sustain bias voltage, the second sustain bias voltage, or a highest voltage of a sustain signal.

18. A method of driving a plasma display apparatus including a scan electrode and a sustain electrode, the method comprising:
supplying a first reset signal, of which a lowest voltage is a first voltage, to the scan electrode during reset periods of a plurality of subfields, and supplying a scan signal, of which a lowest voltage is a third voltage lower than the first voltage, to the scan electrode during address periods following the reset periods; and
supplying a first sustain bias voltage to the sustain electrode for a supply time shorter than a supply time of the first reset signal in the reset periods, and supplying a second sustain bias voltage higher than the first sustain bias voltage to the sustain electrode during the address periods.

19. The method of claim 18, further comprising supplying the first reset signal to the scan electrode during reset periods of some of the plurality of subfields, and supplying a second reset signal, of which a lowest voltage is a second voltage different from the first voltage, to the scan electrode in the other subfields except the same subfields from the plurality of subfields.

20. The method of claim 19, wherein the second sustain bias voltage changes in each of the plurality of subfield.
